(19) United States
(12) Patent Application Publication
(10) Pub. No.: US 2019/0342811 A1
(43) Pub. Date: Nov. 7, 2019

(54) Network-Congestion Based Connection Manager

(71) Applicant: Google LLC, Mountain View, CA (US)

(72) Inventors: Erik Richard Stauffer, Sunnyvale, CA (US); Aamir Akram, San Jose, CA (US); Jibing Wang, Saratoga, CA (US)

(73) Assignee: Google LLC, Mountain View, CA (US)

(21) Appl. No.: 15/972,140

(22) Filed: May 5, 2018

(51) Int. Cl. H04W 36/22; H04L 12/26; H04B 17/318; H04W 28/02; H04W 48/18

(52) U.S. Cl. CPC H04W 36/22; H04L 43/0882; H04W 28/10; H04W 28/0289; H04W 48/18; H04B 17/318

(57) ABSTRACT

The present disclosure describes techniques and systems for selecting and connecting to a wireless-communication network based on network-congestion levels. These techniques and systems include a user device that monitors metrics of a WiFi wireless-communication network to determine a network-congestion level of the WiFi wireless-communication network. The user device also monitors other metrics of a Global System for Mobile (GSM) wireless-communication network to determine another network-congestion level. The user device then selects and connects to a preferred wireless-communication network, where the user device bases the selection on the determined network-congestion levels.

### BACKGROUND

Wireless communication has become a leading medium for accessing and uploading data. To communicate wirelessly, a user device may connect to a wireless-communication network (e.g., connect to a router of a WiFi wireless-communication network) or to a wireless Global System for Mobile (GSM) communications network (e.g., connect to a base station of a cellular network). If both the WiFi wireless-communication network and the GSM wireless-communication network are available to the user device, the user device typically determines to which network to connect based on a signal-strength metric, such as a Reference Signal Received Power (RSRP) metric or a Received Signal Strength Indicator (RSSI) metric.

Connecting to a wireless-communication network based on a signal-strength metric only, however, does not guarantee good performance (e.g., a consistent connectivity or a high data rate) that a user might expect. For example, even though a strength of a signal between the user device and an access point of a wireless-communication network might be strong at the onset, other signals that connect other devices to the access point may introduce destructive interferences and result in intermittent disconnections between the user device and the access point. As another example, the access point or the wireless-communication network itself may have limitations in terms of bandwidth and not be capable of exchanging data at the desired data rate if either is supporting other devices.

### SUMMARY

The present disclosure describes techniques and systems for selecting and connecting to a wireless-communication network based on network-congestion levels. Such techniques and systems include a user device that monitors metrics of a WiFi wireless-communication network to determine a network-congestion level of the WiFi wireless-communication network. The user device also monitors other metrics of a Global System for Mobile (GSM) wireless-communication network to determine another network-congestion level. The user device then selects and connects to a preferred wireless-communication network, where the user device bases the selection on the determined network-congestion levels.

In some aspects, a user device determines a first network-congestion level of a first wireless-communication network. The user devices monitors a first metric of the first wireless-communication network to establish a basis for determining the first network-congestion level. The user device also determines a second network-congestion level of a second wireless-communication network. As part of the determination, the user device monitors a second metric of the second wireless-communication network to establish a basis for determining the second network-congestion level. The user device then selects a preferred wireless-communication network from the first wireless-communication network and the second wireless-communication network, based on the determined first and second network-congestion levels, and then connects to the preferred wireless-communication network.

In other aspects, a system includes a processor and a computer-readable media (CRM). The CRM includes instructions that, when executed by the processor, cause the system to monitor a first metric of a first wireless-communication network and a second metric of a second wireless-communication network. Based on the first and second monitored metrics, the system determines, respectively, a first network-congestion level and a second network-congestion level. The system then selects a preferred wireless-communication network from the first wireless-communication network and the second wireless-communication network, based on the first and second determined network-congestion levels, and then connects to the preferred wireless-communication network.

In further aspects, a user device monitors a first wireless communication-network for a first received signal strength indicator (RSSI) and monitors a second wireless-communication network for a second RSSI. The user device receives a first network congestion level-indicator and a second network congestion-level indicator. Based on the first and second monitored RSSIs and the first and second received network congestion-level indicators, the user device selects a preferred wireless-communication network and then connects to the preferred wireless communication network.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, a reader should not consider the summary to describe essential features nor limit the scope of the claimed subject matter.

### BRIEF DESCRIPTION OF THE DRAWINGS

This document describes details of one or more aspects of selecting and connecting to a wireless-communication network based on network-congestion levels. The use of the same reference numbers in different instances in the description and the figures may indicate like elements:

FIG. 1 illustrates an example operating environment in which a user device selects and connects to a wireless-communication network.

FIG. 2 illustrates example details of a user device monitoring a WiFi wireless-communication network to determine a network-congestion level.

FIG. 3 illustrates example details of a user device monitoring a Global System for Mobile (GSM) wireless-communication network to determine a network-congestion level.

FIG. 4 illustrates example details of a user device receiving a congestion-level indicator from an access point of a WiFi wireless-communication network.

FIG. 5 illustrates an example details of a user device receiving a congestion-level indicator from a base station of a GSM wireless-communication network.

FIG. 6 illustrates an example configuration of a user interface for selecting settings of a connection-manager module.

FIG. 7 illustrates an example method for selecting and connecting to a preferred wireless-communication network based on monitored network-congestion levels.

FIG. 8 illustrates an example method for selecting and connecting to a preferred wireless-communication network based on monitored received signal strength indicators (RSSIs) and received congestion level indicators.

FIG. 9 illustrates an example method for switching from a first wireless-communication network to a second wireless-communication network based on monitored congestion-level indicators.

### DETAILED DESCRIPTION

Operating Environment

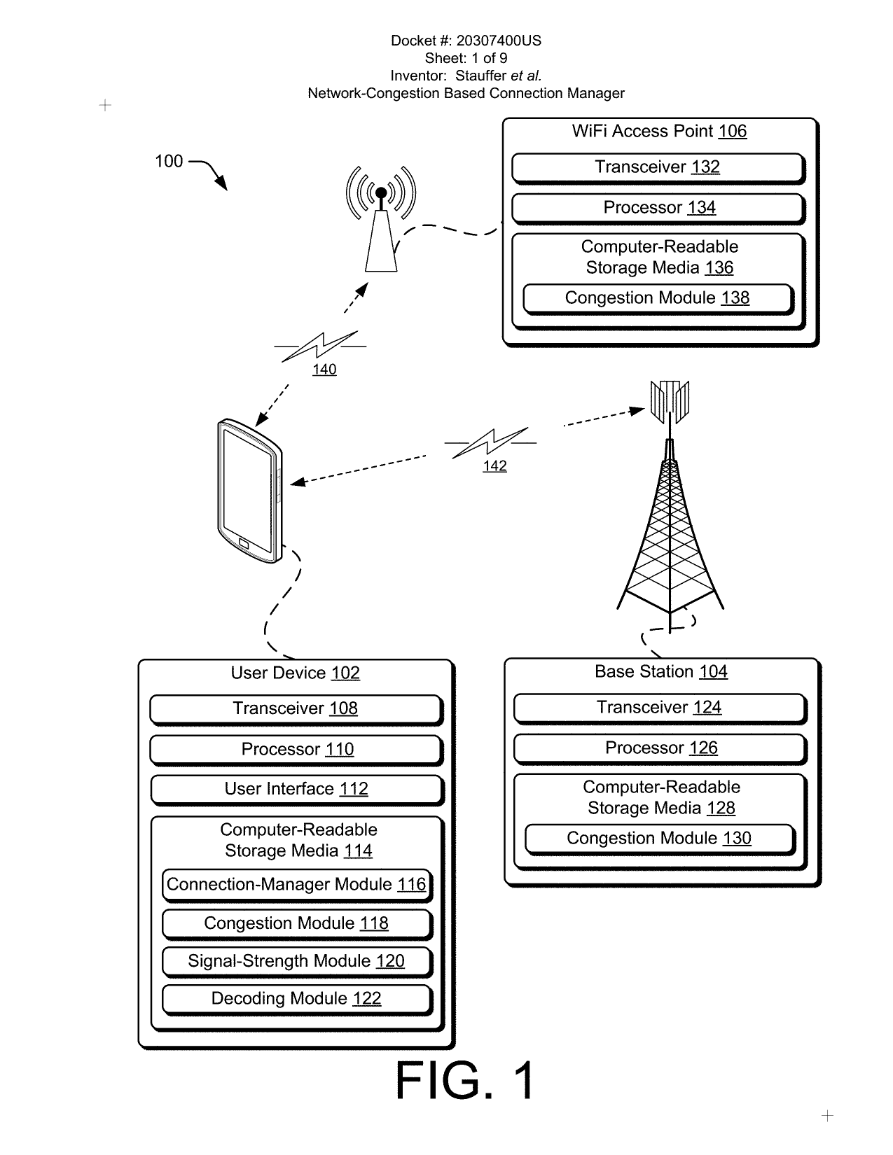

FIG. 1 illustrates an example operating environment 100 in which a user device selects and connects to a wireless-communication network. In this example, the operating environment 100 includes a user device 102, a base station 104 that supports a Global System for Mobile communication (GSM) wireless-communication network, and a WiFi access point 106 that supports a WiFi wireless-communication network.

The user device 102 also includes a transceiver 108 that supports communication protocols associated with either the GSM wireless-communication network or the WiFi wireless-communication network. Example GSM wireless-communication network communication protocols include Long Term Evolution (LTE) and Fifth-Generation New Radio (5G NR) protocols, while example WiFi wireless-communication network communication protocols include IEEE 802.11 protocols. In addition, the user device 102 and transceiver 108 may support other wireless-communication protocols of other operating environments, such as a Worldwide Interoperability for Microwave Access (WiMax) protocol, a High Speed Packet Access (HSPA) protocol, or an Evolved HSPA (HSPA+) protocol.

The user device 102 also includes a processor 110, a user interface 112, and a computer-readable storage media (CRM) 114, which stores modules of code or executable instructions in the form of a connection-manager module 116, a congestion module 118, a signal-strength module 120, and a decoding module 122. Although FIG. 1 depicts the user device 102 as a smartphone, the user device 102 may instead be any device with wireless communication capabilities, such as a mobile gaming console, a tablet, a laptop, an advanced driver assistance system (ADAS), handset, a communication system of an automobile, a point-of-sale (POS) terminal, a health monitoring device, a drone, a camera, a media-streaming dongle, a wearable smart-device, an internet-of-things (IoT) device, a personal digital assistant, a navigation device, a mobile-internet device (MID), a wireless hotspot, a femtocell, or a broadband router.

The processor 110 of the user device 102 can execute modules of instructions or code stored by the computer-readable storage media (CRM) 114 to cause the user device 102 to perform operations or implement various device functionalities. In some cases, the processor 110 is an application processor (e.g., multicore processor) or a system-on-chip (SoC) with other components of the user device integrated therein. The CRM 114 may include any suitable type of memory media or storage media, such as read-only memory (ROM), programmable ROM (PROM), random access memory (RAM), static RAM (SRAM), or Flash memory. In the context of this discussion, the CRM 114 of the user device 102 is a hardware-based storage media, which does not include transitory signals or carrier waves. In some cases, the CRM 114 stores one or more of firmware, an operating system, or applications of the user device 102 as modules of instructions, code, or information. The processor 110 executes the modules of instructions or code to implement various functionalities of the user device 102. In this example, the CRM 114 includes storing modules of instructions or code for implementing one or more functions associated with connection management, assessing network-congestion levels of wireless-communication networks available to the user device 102, and sensing signal strengths of wireless-communication networks available to the user device 102.

The base station 104 includes a transceiver 124 and a processor 126. The transceiver 124 of the base station 104 supports wireless-communication protocols as associated with a GSM wireless-communication network, such as LTE and 5G NR protocols. The processor 126 of the base station 104 can execute modules of instructions or code stored by the computer-readable storage media (CRM) 128 to cause the base station 104 to perform operations or implement various device functionalities. In some cases, the processor 110 is an application processor (e.g., multicore processor) or a system-on-chip (SoC) with other components of the user device integrated therein. The CRM 128 may include any suitable type of memory media or storage media, such as read-only memory (ROM), programmable ROM (PROM), random access memory (RAM), static RAM (SRAM), or Flash memory. In the context of this discussion, the CRM 128 of the base station 104 is a hardware-based storage media, which does not include transitory signals or carrier waves. In some cases, the CRM 128 stores one or more of firmware, an operating system, or applications of the base station 104 as modules of instructions, code, or information. The processor 126 executes the modules of instructions or code to implement various functionalities of the base station 104. In this example, the CRM 128 includes storing modules of instructions or code in the form of a congestion module 130 that assesses a network-congestion level of a GSM wireless-communication network that the base station 104 supports.

The WiFi access point 106 includes a transceiver 132 and a processor 134. The transceiver 132 of the WiFi access point 106 supports wireless-communication protocols as associated with a WiFi wireless-communication network, such as IEEE 802.11 protocols. The processor 134 of the WiFi access point 106 can execute modules of instructions or code stored by the computer-readable storage media (CRM) 136 to cause the WiFi access point 106 to perform operations or implement various device functionalities. In some cases, the processor 134 is an application processor (e.g., multicore processor) or a system-on-chip (SoC) with other components of the user device integrated therein. The CRM 136 may include any suitable type of memory media or storage media, such as read-only memory (ROM), programmable ROM (PROM), random access memory (RAM), static RAM (SRAM), or Flash memory. In the context of this discussion, the CRM 136 of the WiFi access point 106 is a hardware-based storage media, which does not include transitory signals or carrier waves. In some cases, the CRM 136 stores one or more of firmware, an operating system, or applications of the base station 104 as modules of instructions, code, or information. The processor 134 executes the modules of instructions or code to implement various functionalities of the base station 104. In this example, the CRM 136 includes storing modules of instructions or code in the form of a congestion module 138 that assesses a network-congestion level of a WiFi wireless-communication network that the WiFi access point 106 supports.

In the example operating environment 100, the WiFi access point 106 exposes the user device 102 to a first wireless-communication network (e.g., a WiFi wireless-communication network) and the base station 104 exposes the user device to a second wireless-communication network (e.g., a GSM wireless-communication network). As part of the operating environment 100, the processor 110 of the user device 102 can execute instructions stored on the connection-manager module 116, the congestion module 118, the signal-strength module 120, or the decoding module 122 such that the user device 102 can determine a preferred wireless-communication network for wireless communications. The user device 102 can then select and connect to either to either the WiFi access point 106 (via an available wireless-communication link 140) or to the base station 104 (via an available wireless-communication link 142).

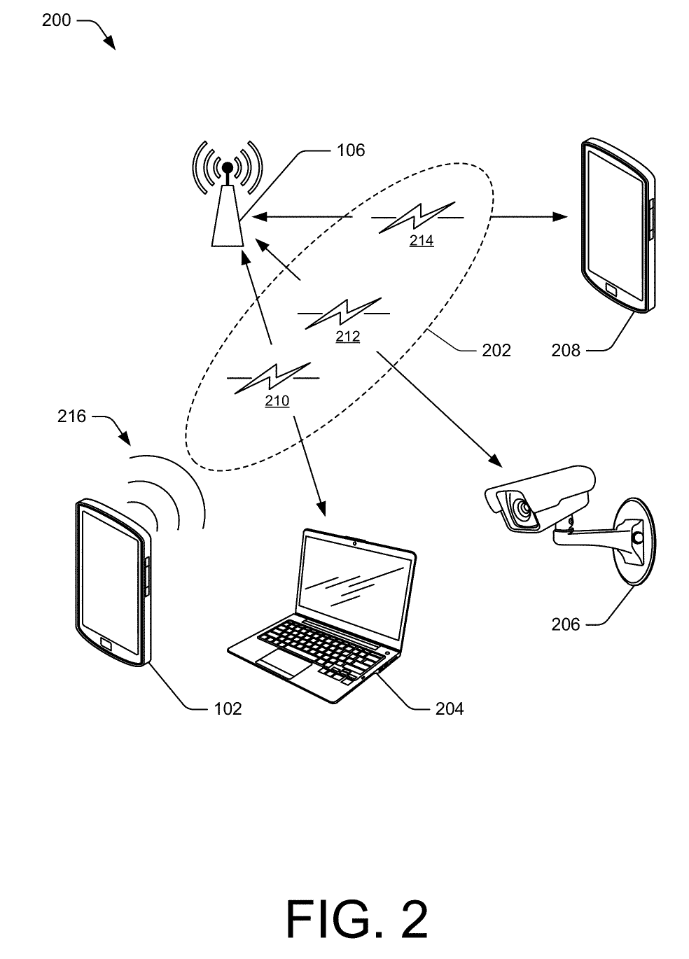

FIG. 2 illustrates example details 200 of a user device monitoring a WiFi wireless-communication network to determine a network-congestion level. The example details 200 may be details as associated with the operating environment 100 of FIG. 1.

As illustrated by the example details 200, the WiFi access point 106 is supporting a WiFi wireless-communication network 202 that includes a plurality of wireless devices communicating wirelessly. The plurality of wireless devices includes a laptop 204, a security camera 206, and a smartphone 208. As part of the WiFi wireless-communication network 202, the laptop 204 connects to the WiFi access point 106 via a wireless-communication link 210, the security camera 206 connects to the WiFi access point 106 via a wireless-communication link 212, and the smal phone 208 connects to the WiFi access point 106 via a wireless-communication link 214. Each of the wireless-communication links 210-214 is a bi-directional wireless-communication link, via which the WiFi access point 106 and each of the respective wireless devices 204-208 exchange data. The combination of the wireless devices 204-208 and the wireless-communication links 210-214 is by way of example only, and is but one of many possible combinations of wireless devices and communication links that may be available to the WiFi access point 106.

As illustrated by FIG. 2, the user device 102 actively performs a sensing function 216 (via its transceiver 108). The user device 102, via the sensing function 216, monitors a variety of metrics that may be indicative of a network-congestion level of the WiFi wireless-communication network 202. To perform the sensing function 216, the transceiver 108 may sense a number communication paths that receive multiple streams of data. The transceiver 108 may include a multiple-input and multiple output (MIMO) antenna array that receives respective beams carrying data that other user devices are transmitting to or receiving from the base station 104. The transceiver 108 may also include demodulation circuitry that extracts the data from such respective beams or circuitry that detects signal-strength levels of the respective beams.

Continuing with FIG. 2, and as part of the sensing function 216, the user device 102 may monitor quantities of certain types of data that the WiFi access point 106 and the wireless devices 204-208 are actively exchanging via the wireless-communication links 210-214. As part of the monitoring, and via the processor 110 executing instructions stored in the decoding module 122, the user device 102 may decode the received data and associate the received data with types of frames or packets of a particular wireless-communication protocol. These types of data may include preambles, request-to-send (RTS) frames, or clear-to-send (CTS) frames that the WiFi access point 106 exchanges with the wireless devices 204-208. The monitored metric (e.g., the monitored quantities of specific types of exchanged data) is an example indicator that may serve as a basis for determining a network-congestion level of the wireless-communication network 202.

As another example, the user device 102 may monitor periods of time associated with reactions or responses of wireless communications supported by the WiFi wireless-communication network 202. Such periods of time can include, for example, a latency of an access time to a server or a duration of a listen-before-talk (LBT) back off window. The monitored metric (e.g., the monitored periods of time associated with reactions or responses) is another example indicator that may serve as a basis for determining a network-congestion level of the WiFi wireless-communication network 202.

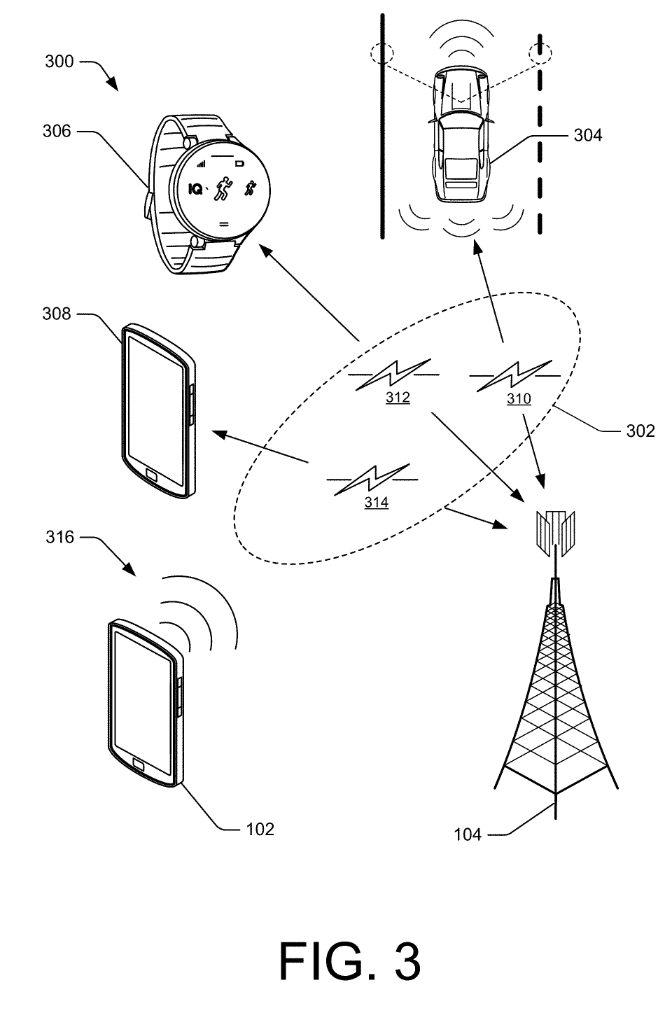

FIG. 3 illustrates example details 300 of a user device monitoring a Global System for Mobile (GSM) wireless-communication network to determine a network-congestion level. The example details 200 may be details as associated with the operating environment 100 of FIG. 1.

As illustrated by the example details 300, the base station 104 is supporting a GSM wireless-communication network 302 that includes a plurality of wireless devices communicating wirelessly. The plurality of wireless devices includes an automobile driver alertness detection (DAD) system 304, a smartwatch 306, and a smartphone 308. As part of the wireless-communication network 302, the DAD system 304 connects to the base station 104 via a wireless-communication link 310, the smartwatch 306 connects to the base station via a wireless-communication link 312, and the smartphone 308 connects to the base station 104 via a wireless-communication link 314. Each of the wireless-communication links 310-314 is a bi-directional wireless-communication link, via which the WiFi access point 106 and each of the respective wireless devices 304-308 exchange data. The combination of the wireless devices 304-308 and the wireless-communication links 310-314 is by way of example only, and is but one of many possible combinations of wireless devices and communication links that may be available to the base station 104.

Continuing with FIG. 3, the user device 102 actively performs a sensing function 316 (via its transceiver 108). Via the sensing function 316, the user device 102 may monitor quantities of certain types of data that the base station 104 and the wireless devices 304-308 are actively exchanging via the wireless-communication links 310-314. As part of the monitoring, and via the processor 110 executing instructions stored in the decoding module 122, the user device 102 may decode and assess quantities of resource blocks that the base station 104 exchanges with the wireless devices 304-308. The user device may also decode and assess quantities of preambles associated with physical random access channel (PRACH) communications. The monitored metric (e.g., the monitored quantities of exchanged resource blocks or preambles) is an example indicator that may serve as a basis for determining a network-congestion level of the GSM wireless-communication network 302.

Using one or more of the examples of the monitored metrics as detailed by FIG. 2 and FIG. 3, the processor 110 of the user device 102 can execute instructions stored in the congestion module 118 to determine a network-congestion level of the WiFi wireless-communication network 202 as well as a network-congestion level of the GSM wireless-communication network 302. Determining the respective network-congestion levels can incorporate factors of each of the wireless-communication networks. For example, with respect to the WiFi wireless-communication network 202, determining the network-congestion level can incorporate factors related to a communication bandwidth of hardware supporting the WiFi access point 106 or a capacity of a server supporting the WiFi wireless-communication network 202. With respect to the GSM wireless-communication network 302, determining the network-congestion level can incorporate factors related to a known communication bandwidth of hardware supporting the base station 104 or a known resource block capacity available to the base station 104.

Alternatively, the user device 102 may receive congestion-level indicators. In such an instance, the WiFi access point 106 and the base station 104 may determine respective congestion-level indicators and provide the respective congestion-level indicators to the user device 102. In the case of the WiFi access point 106, determining a congestion-level indicator may performed by the processor 134 executing monitoring software (not illustrated) in conjunction with the congestion module 138. Such a monitoring software could be, for example, a router monitoring software. In the case of the base station 104, determining a congestion-level indicator may performed by the processor 126 executing scheduling software (not illustrated) in conjunction with the congestion module 130. Such a scheduling software could be, for example, an Evolved Nobe B (eNB) scheduling software.

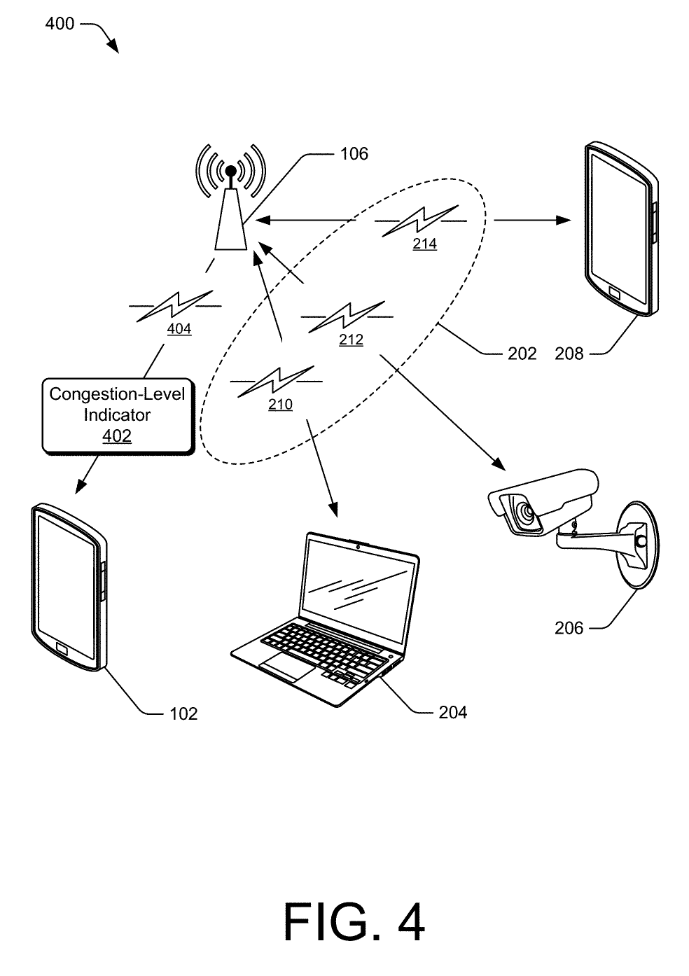

FIG. 4 illustrates example details 400 of a user device receiving a congestion-level indicator from an access point of a WiFi wireless-communication network. The details 400 may include one or more elements of FIG. 1 and FIG. 2.

As illustrated, WiFi access point 106 and the wireless devices 204-208 are actively exchanging data via the wireless-communication links 210-214 as part of the wireless-communication network 202. However, in this example instance, the WiFi access point 106 is directly monitoring its transceiver 132 to measure quantities of certain types of data that it is exchanging with the wireless devices 204-208. Based on the measured quantities of certain types of data, the congestion module 138 determines a congestion-level indicator 402 that indicates a network-congestion level of the WiFi wireless-communication network 202. The determination may incorporate factors such as communication bandwidth of hardware supporting the WiFi access point 106 or a capacity of a server supporting the WiFi wireless-communication network 202. The WiFi access point 106 then transmits the congestion-level indicator 402 to the user device 102 via a unidirectional downlink wireless connection 404, providing the user device 102 with data that the connection-manager module 116 may use to determine and select a preferred wireless-communication network.

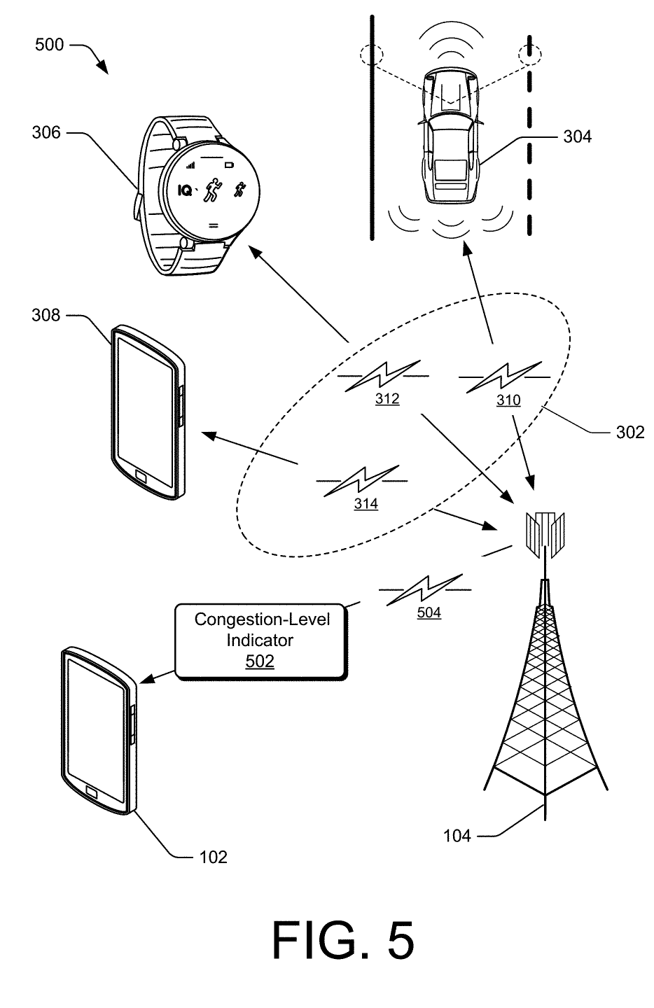

FIG. 5 illustrates an example details 500 of a user device receiving a congestion-level indicator from a base station of a GSM wireless-communication network. The details 500 may include one more elements of FIG. 1 and FIG. 3.

As illustrated, the base station 104 and the wireless devices 304-308 are actively exchanging data via the wireless-communication links 310-314 as part of the GSM wireless-communication network 302. However, in this example instance, the base station 104 is directly monitoring its transceiver 124 to measure quantities of certain types of data that it is exchanging with the wireless devices 304-308. Based on the measured quantities of certain types of data, the congestion module 130 determines a congestion-level indicator 502 that indicates a network-congestion level of the GSM wireless-communication network 302. The determination may incorporate factors related to a known communication bandwidth of hardware supporting the base station 104 or a known resource block capacity available to the base station 104. The base station 104 then transmits the congestion-level indicator 502 to the user device 102 via a unidirectional downlink wireless connection 504, providing the user device 102 with data that connection-manager module 116 may use to determine and select a preferred wireless-communication network.

In certain instances, the user device 102 may combine a self-determined network-congestion level (as illustrated and described by FIG. 3 and FIG. 4) with one of the congestion-level indicators determined by the WiFi access point 106 or the base station 104 (as illustrated and described by FIG. 3 and FIG. 5) when determining and selecting a preferred wireless-communication network. Motivations for combining may include, for example, limited sensing capabilities by the user device 102, encryption of data exchanged by either of the wireless-communication networks 202 and 302, restrictions placed upon the user device 102 by either the WiFi access point 106 or the base station 104, or the like.

Using combinations of elements as described in FIGS. 2-5, a user device 102 may support a variety of network selection modes. Each network selection mode, when chosen by a user of the user device 102, may impact power consumption of the user device 102 or quality of wireless communications as experienced by the user. Choosing a network selection mode may further impact data usage and expenses as associated with the user connecting to a particular wireless-communication network.

In one example selection mode, a network-congestion level selection mode, the user device 102 may select a preferred wireless-communication network simply based on the respective network-congestion levels. While in the network-congestion level selection mode, the user device 102 may, via the processor 110 executing instructions stored in the congestion module 118, determine respective network congestion levels or receive respective network congestion-level indicators. The user device may then, via the processor 110 executing instructions stored in the connection-manager module 116, select a preferred wireless-communication network based on the respective network congestion levels.

In another example selection mode, an enhanced selection mode, the user device 102 may select a preferred wireless-communication network based on the network-congestion levels in combination with RSSI metrics monitored by the user device 102. While in the enhanced selection mode, the user device 102 can, via the processor 110 executing instructions stored in the signal-strength module 120, monitor circuitry of the transceiver 108 for RSSI metrics associated with signals emitted from the WiFi access point 106 or the base station 104. The user device 102 may use the RSSI metrics as part of a hybrid selection metric (HSM) to select a preferred wireless-communication network. Such an example HSM relationship that may be included in the code of the connection-manager module 116 is as follows:

HSM=(1−network_congestion_level)*RSSI Equation 1

The user device 102 may also simply operate in a signal-strength selection mode where it selects a preferred wireless-communication network based on the monitored RSSI metrics. While in the signal-strength selection mode, the user device 102 does not include network congestion levels as part of its selection process.

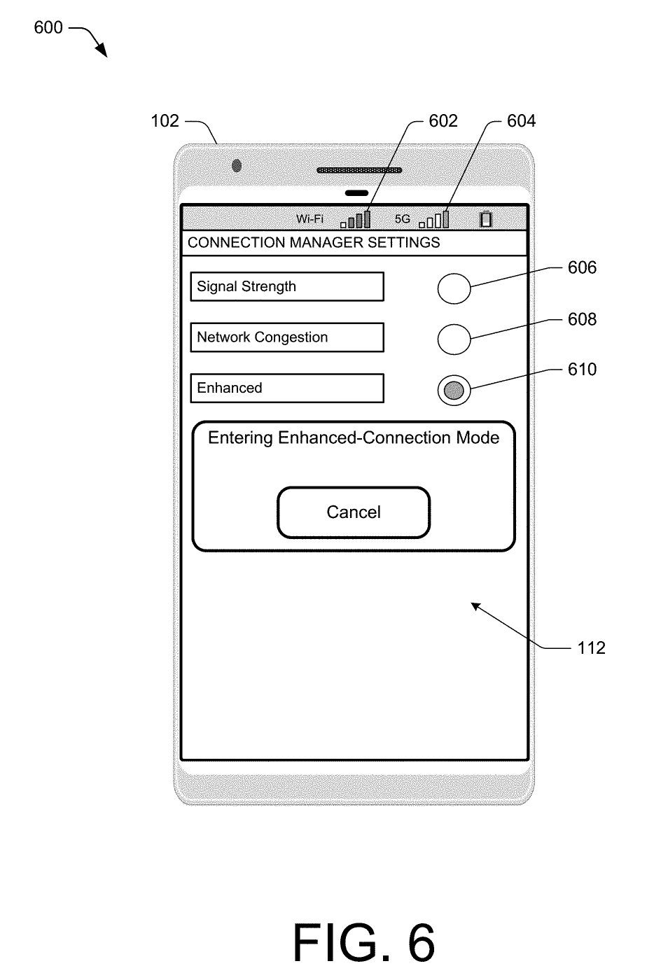

FIG. 6 illustrates an example configuration 600 of a user interface for selecting settings of a connection-manager module. The user interface may be the user interface 112 of FIG. 1 and the connection-manager module may be the connection-manager module 116 of FIG. 1. Selecting the settings of the connection-manager module 116 may, in effect, select a network selection mode as described above.

In the example configuration 600, the user device 102 presents the user interface 112 through a visible portion of a display of the user device 102. Such a display may also include a touch screen or touch-sensitive overlay for receiving touch input from the user. The user interface 112 includes a received signal level strength indicator (RSSI) gauge 602 that indicates a strength of a signal that the user device 102 receives from the WiFi access point 106. The user interface 112 also includes another RSSI gauge 604 that indicates a strength of a signal that the user device 102 receives from the base station 104. Although the circuitry of the transceiver 108 may detect signals ranging from 0 decibels (dB) to −120 dB, executable code of the signal-strength module 120 may include instructions indicating that a strength of a signal exceeding a threshold of −60 dB is not acceptable and cause the user device 102 to display relative strengths for signal strengths ranging from 0 dB to −60 dB (e.g., the graduating bars the RSSI gauge 602 and RSSI gauge 604). In this example, the strength of the signal received from the base station 104 (e.g., the “5G” signal) is stronger (e.g., closer to 0 dB) than the strength of the signal received from the WiFi access point 106 (e.g., the “Wi-Fi” signal).

The configuration 600 also includes a selectable menu for a user to select settings of the connection-manager module 116. As illustrated by FIG. 6, and in accordance with earlier described examples, the selectable menu includes a signal-strength selector 606 for configuring the connection-manager module 116 to cause the user device 102 to operate in a signal-strength selection mode. Selecting the network-congestion selector 608 configures the connection-manager module 116 to cause the user device 102 to operate in a network-congestion level selection mode. The selectable menu also includes an enhanced selector 610 for configuring the connection-manager module 116 to cause the user device 102 to operate in an enhanced-connection selection mode.

The user interface 112 having the configuration 600 is but one of many possible user interface and configuration combinations for selecting a mode of operation of the user device 102. Although FIG. 6 illustrates the user device 102 as a smart phone with a touch screen, a type of the user device 102 may afford alternative user interfaces. For example, if user device 102 is a laptop, the user interface 112 may include for example, one or more of a mouse, a track pad, or a keyboard for configuring the connection-manager module 116. As another example, the user device 102 may use, as part of the user interface 112, voice or command recognition for configuring the connection-manager module 116.

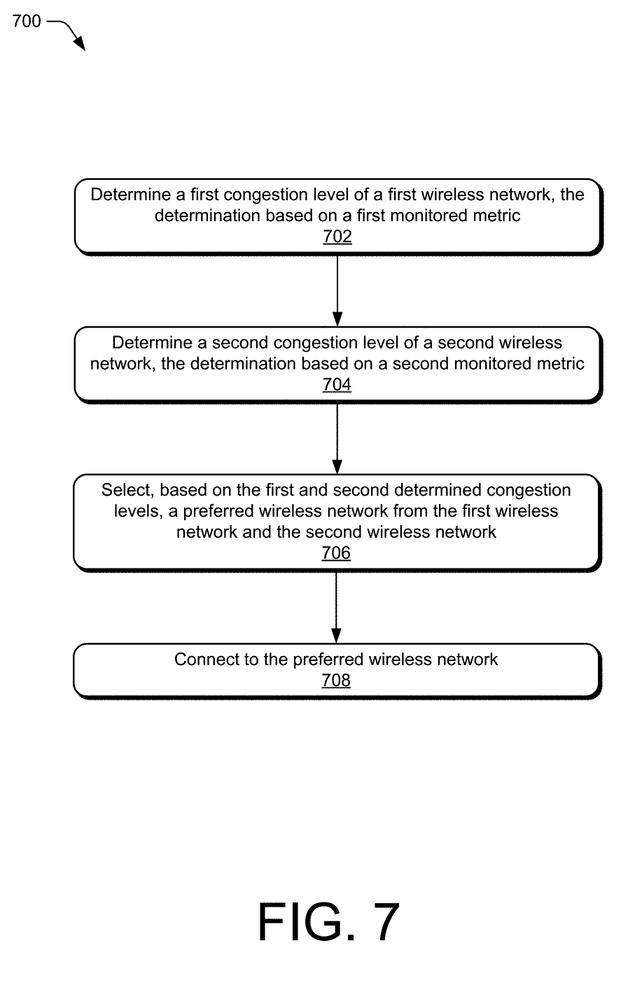

FIG. 7 illustrates an example method 700 for selecting and connecting to a preferred wireless-communication network based on monitored network-congestion levels. A user device, such as the user device 102 of FIG. 1, may perform the method 700 using elements of FIG. 1, FIG. 2, and FIG. 3.

At 702, the user device 102 determines a first network-congestion level of a first wireless-communication network. The first wireless-communication network may be, for example, the WiFi wireless-communication network 202 of FIG. 2. The congestion user device 102 bases the determination on a first monitored metric that may, as an example, be a metric that is indicative of quantities of certain types of data actively exchanged within the WiFi wireless-communication network 202. As another example, the first monitored metric may be indicative of periods of time associated with reactions or responses of wireless communications within the WiFi wireless-communication network 202.

At 704, the user device 102 determines a second network-congestion level of a second wireless-communication network. The second wireless-communication network may be, for example, the GSM wireless-communication network 302 of FIG. 3. The user device 102 bases the determination on a second monitored metric that may, as an example, may be a metric that is indicative of quantities of resource blocks exchanged within the GSM wireless-communication network 302. As another example, the second monitored metric may be indicative of quantities of preambles associated with physical random access channel communications within the GSM wireless-communication network 302.

At 706, the user device 102 selects, based on the first and second determined network-congestion levels, a preferred wireless-communication network from the first wireless-communication network (e.g., the example WiFi wireless-communication network 202) and the second wireless-communication network (e.g., the example GSM wireless-communication network 302). At 708, the user device 102 connects to the preferred wireless-communication network.

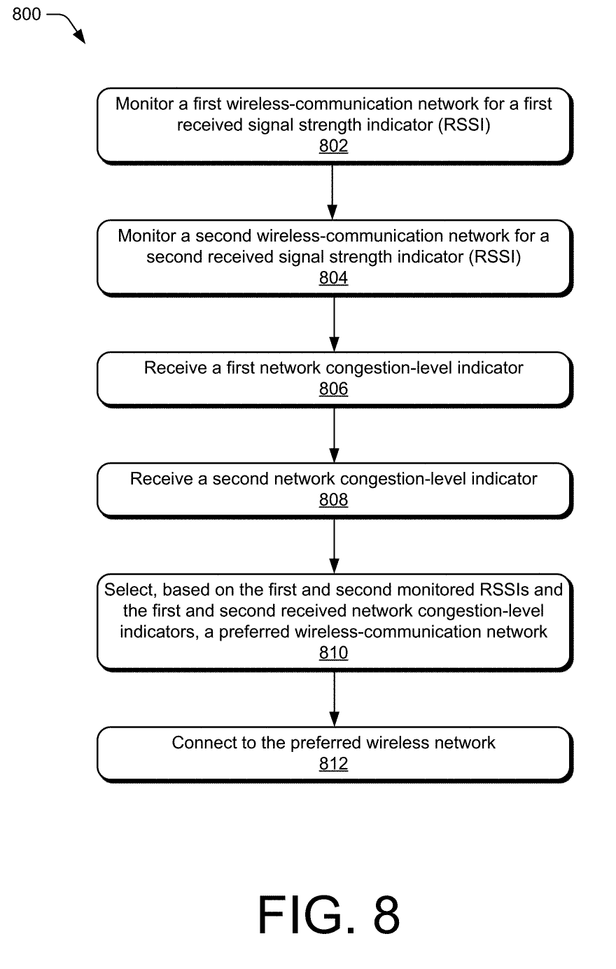

FIG. 8 illustrates an example method 800 for selecting and connecting to a preferred wireless-communication network based on monitored received signal strength indicators and received congestion level indicators. A user device, such as the user device 102 of FIG. 1, may perform the method 800 using elements of FIG. 1, FIG. 4, and FIG. 5.

At 802, the user device 102 monitors a first wireless-communication network for a first received signal strength indicator (RSSI). The first RSSI may be monitored via the processor 110 executing code of the signal-strength module 120 and the first wireless-communication network may be the WiFi wireless-communication network 202.

At 804, the user device 102 monitors a second wireless-communication network for a second received signal strength indicator (RSSI). The second RSSI may be monitored via the processor 110 executing code of the signal-strength module 120 and the second wireless-communication network may be the GSM wireless-communication network 302.

At 806, the user device 102 receives a first network congestion-level indicator. The first network congestion-level indicator may be, for example, the congestion-level indicator 402 of FIG. 4 that is associated to the WiFi wireless-communication network 202.

At 808, the user device 102 receives a second indicator that indicates a network-congestion level of a second wireless-communication network. The second indicator may be, for example, the congestion-level indicator 502 of FIG. 5 that is associated to the GSM wireless-communication network 302.

At 810, the user device 102 selects, based the first and second monitored RSSIs and the first and second received network congestion-level indicators, a preferred wireless-communication network from the first wireless-communication network and the second wireless-communication network. The first and second monitored RSSIs and the first and second received network congestion-level indicators may, in some instances, comprise a hybrid selection metric (HSM). At 812, the user device 102 connects to the preferred wireless-communication network.

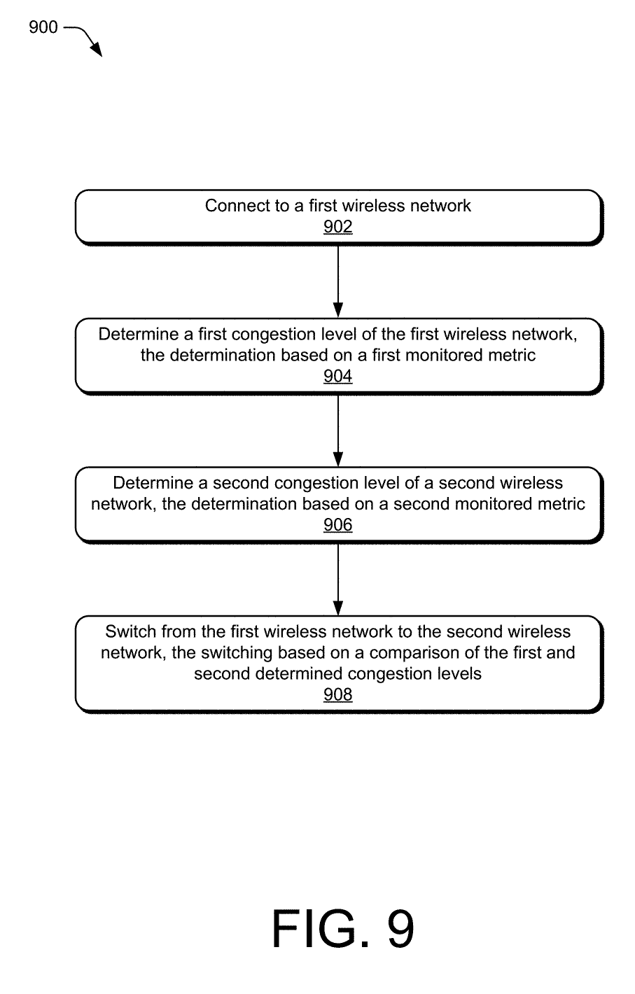

FIG. 9 illustrates an example method 900 for switching from a first wireless-communication network to a second wireless-communication network based on monitored congestion-level indicators. A user device, such as the user device 102 of FIG. 1, may perform the method 900 using elements of FIG. 1, FIG. 2, and FIG. 3.

At 902, the user device 102 connects to a first wireless-communication network. The first wireless-communication network may be, for example, the WiFi wireless-communication network 202 of FIG. 2.

At 904, the user device 102 determines a first network-congestion level of the first wireless-communication network where the determination is based on a first monitored metric. If, for example, the first wireless-communication network is the WiFi wireless-communication network 202, the determination may be based on a metric monitored by the user device 102 that is indicative of quantities of certain types of data actively exchanged within the WiFi wireless-communication network 202. As another example, the determination may be based on a metric monitored by the user device 102 that is indicative of periods of time associated with reactions or responses of wireless communications within the WiFi wireless-communication network 202.

At 906, the user device 102 determines a second network-congestion level of a second wireless-communication network, where the determination is based on a second monitored metric. If, for example, the second wireless-communication network is the GSM wireless-communication network 302, the determination may be based on a metric that is indicative of quantities of resource blocks exchanged within the GSM wireless-communication network 302. As another example, the second monitored metric may be indicative of quantities of preambles associated with physical random access channel communications within the GSM wireless-communication network 302.

At 908, the user device 102 switches from the first wireless-communication network to the second wireless-communication network (e.g., disconnects from the WiFi wireless-communication network 202 and connects to the GSM wireless-communication network 302). Such a switching is based on a comparison of the first and second determined network-congestion levels.

The methods 700-900 are but few of many possible methods of the user device 102 determining a preferred connection to a wireless-communication network. Although the methods 700-900 recite examples of the user device 102 managing wireless connections between the example WiFi wireless-communication network 202 and the example GSM wireless-communication network 302, the user device 102 may, using like methods, determine and select preferred connection from available connections to like wireless-communication networks (e.g., determine and select a preferred connection from available connections to two WiFi wireless-communication networks or two GSM wireless-communication networks). Additionally, and in general, the methods 700-900 (and associated permutations) are applicable to wired and wireless-communication networks that may be other than the example WiFi and GSM wireless-communication networks described herein.

What is claimed is:

1. A method for a user device to connect to a wireless-communication network, the method performed by the user device and comprising:
determining a first network-congestion level of a first wireless-communication network, the first network-congestion level determined based on a first metric that is monitored by the user device;
determining a second network-congestion level of a second wireless-communication network, the second network-congestion level determined based on a second metric that is monitored by the user device;
selecting, based on the first and second determined network-congestion levels, a preferred wireless-communication network from the first wireless-communication network and the second wireless-communication network; and
connecting to the preferred wireless-communication network.

2. The method of claim 1, wherein the first monitored metric indicates quantities of certain types of data that an access point of the first wireless-communication network is actively exchanging with a plurality of wireless devices.

3. The method of claim 2, wherein the certain types of data include preambles, request-to-send (RTS) frames, or clear-to-send (CTS) frames.

4. The method of claim 1, wherein the first monitored metric indicates periods of time associated with reactions or responses of wireless communications supported by the first wireless-communication network.

5. The method of claim 4, wherein the periods of time associated with reactions or responses of the wireless communications includes latencies of access times to a server or a durations of listen-before-talk (LBT) back off windows.

6. The method of claim 1, wherein determining the first network-congestion level incorporates factors including a communication bandwidth of hardware supporting an access point of the first wireless-communication network or a capacity of a server supporting the first wireless-communication network.

7. The method of claim 1, wherein the second monitored metric indicates quantities of certain types of data that a base station of the second wireless-communication network is actively exchanging with a plurality of wireless devices.

8. The method of claim 7, wherein the second monitored metric is a quantity of resource blocks that the base station is exchanging with the plurality of wireless devices or a quantity of preambles associated with physical random access channel (PRACH) communications within the second wireless-communication network.

9. The method of claim 1, wherein determining the second network-congestion level incorporates factors including communication bandwidth of hardware supporting a base station or a known resource block capacity available to the base station.

10. The method of claim 1, wherein the selecting is further based on received signal strength indicator (RSSI) metrics, as monitored by the user device, of the first and second wireless-communication networks.

11. A system comprising:
a processor; and
a computer-readable storage media storing instructions that, upon execution by the processor, cause the processor to:
monitor a first metric of a first wireless-communication network;
monitor a second metric of a second wireless-communication network;
determine a first network-congestion level of a first wireless-communication network based on the first monitored metric;
determine a second network-congestion level of the second wireless-communication network based on the second monitored metric; and
connect to a preferred wireless-communication network, the preferred wireless-communication network selected from the first wireless-communication network and the second wireless-communication network based on the determined first and second network-congestion levels.

12. The system of claim 11, wherein the first monitored metric indicates quantities of certain types of data that an access point of the first wireless-communication network is actively exchanging with a plurality of wireless devices.

13. The system of claim 12, wherein the certain types of data include preambles, request-to-send (RTS) frames, or clear-to-send (CTS) frames.

14. The system of claim 11, wherein the first monitored metric indicates periods of time associated with reactions or responses of wireless communications supported by the first wireless-communication network.

15. The system of claim 11, wherein determining the first network-congestion level incorporates factors including a communication bandwidth of hardware supporting an access point of the first wireless-communication network or a capacity of a server supporting the first wireless-communication network.

16. The system of claim 11, wherein the second monitored metric indicates quantities of certain types of data that a base station of the second wireless-communication network is actively exchanging with a plurality of wireless devices.

17. The system of claim 16, wherein the second monitored metric is a quantity of resource blocks that the base station is exchanging with the plurality of wireless devices or a quantity of preambles associated with physical random access channel (PRACH) communications within the second wireless-communication network.

18. The system of claim 17, wherein determining the second network-congestion level incorporates factors including communication bandwidth of hardware supporting a base station or a known resource block capacity available to the base station.

19. A method for a user device to connect to a wireless-communication network, the method performed by the user device and comprising:
monitoring a first wireless-communication network for a first received signal strength indicator (RSSI);
monitoring a second wireless-communication network for a second RSSI;
receiving a first network congestion-level indicator, the first network-congestion level associated to the first wireless-communication network;
receiving a second network-congestion level, the second network-congestion level associated to the second wireless-communication network;
selecting, based on the first and second monitored RSSIs and the first and second received network congestion-level indicators, a preferred wireless-communication network from the first wireless-communication network and the second wireless-communication network; and
connecting to the preferred wireless-communication network.

20. The method of claim 19, wherein the first and second monitored RSSIs and the first and second received network congestion level indicators comprise a hybrid selection metric.
